(19) United States
(12) Patent Application Publication
(10) Pub. No.: US 2007/0016861 A1
(43) Pub. Date: Jan. 18, 2007

(54) Apparatus and methods for implementing modular, context-aware active graphical user interface objects

(75) Inventors: Jyri P. Salomaa, Jorvas (FI); Jouka Mattila, Tampere (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/182,390

(22) Filed: Jul. 15, 2005

(51) Int. Cl. G06F 9/00; G06F 17/00

(52) U.S. Cl. 715/700; 715/762; 715/764

(57) ABSTRACT

The present invention concerns methods and apparatus providing an operating system of a portable communications device with modular active graphical user interface functionality. In methods and apparatus of the present invention, multiple separate and distinct active graphical user interface objects are available for selection by users to perform active graphical user interface display functions. In addition, the present invention provides apparatus and methods that implement context-sensitive active graphical user interface objects. The present invention further provides users with the ability to integrate active graphical user interface objects created by third parties into the operating system of portable communications devices. Thereafter, the active graphical user interface objects created by third parties are available to perform active graphical user interface functions.

### TECHNICAL FIELD

The present invention generally concerns methods and apparatus for implementing graphical user interfaces for use in, for example, mobile cellular telephones and more particularly concerns graphical user interfaces where user-selectable, context-aware active graphical user interface objects are available to provide user-customizable modes of information presentation and operation within a modular graphical user interface environment.

### BACKGROUND

In the field of portable communications devices—such as, for example, mobile cellular telephones—the desire for an ability to customize the portable communications devices to an individual's preferences has increased with each passing year. Initially, mobile telephones were large and bulky and appeared very similar to conventional wired telephones. These early telephones had virtually no inherent capability to be customized by a user.

As the technical sophistication of portable communications devices has increased, the ability to provide user-customizable features has improved. In the past few years, portable communications devices with user-selectable ringing tones and background images have been introduced. These user-customizable features are very popular with users, but represent a very limited ability to modify the overall look and feel of the portable communications device.

The major reason for this is that ringing tones and background images concern only a fraction of the overall functionality of the portable communications device. Message in-boxes, for example, operate within the conventional paradigm of a table. The table typically shows the author of a received message, and the date the message was received. Heretofore there has been relatively limited ability to customize the functional aspects of a user interface—like a message in-box—to the desires of a user.

Accordingly, those skilled in the art desire the ability to customize active elements of a graphical user interface for use in, for example, portable communications devices. In particular, those skilled in the art desire the ability to select particular active graphical user interface objects to perform active graphical user interface functions.

In addition, those skilled in the art desire active graphical user interface objects that increase a user's awareness oftranspiring events. Conventional active graphical user interface objects operate within a relatively limited number of categories. Methods and apparatus desired by those skilled in the art would provide users with context-aware active graphical user interface objects that respond to and report a broader range of information to users.

### SUMMARY OF THE PREFERRED EMBODIMENTS

The foregoing and other problems are overcome, and other advantages are realized, in accordance with the following embodiments of the present invention.

A first embodiment of the present invention comprises a computer program for use in an electronic device having a display for displaying at least one graphical user interface comprised of active graphical user interface objects, the active graphical user interface objects performing active graphical user interface display functions for depicting dynamic information, the computer program fixed in a tangible memory medium and executable by a digital processor of the electronic device, the computer program comprised of the following components: a library of active graphical user interface objects to perform a plurality of active graphical user interface display functions, where a plurality of active graphical user interface objects exist in the library to perform at least one of the plurality of active graphical user interface display functions; an active graphical user interface object selection component for displaying active graphical user interface objects available to perform particular active graphical user interface display functions; for receiving selections of active graphical user interface objects to perform particular active graphical user interface display functions; and for saving the selections; and an active graphical user interface object selection index for recording active graphical user interface objects selected to perform particular active graphical user interface display functions.

A second embodiment of the present invention comprises a memory medium for storing a computer program component executable by a digital processor of an electronic device, where the computer program component operates in combination with an operating system of the electronic device to confer modularity on active graphical user interface objects used by the operating system of the electronic device to perform active graphical user interface display functions, and where the computer program component performs the following operations when executed by the digital processor of the electronic device: displaying a selection menu depicting a plurality of active graphical user interface objects available to perform an active graphical user interface display function; receiving a command selecting a particular active graphical user interface object to perform the active graphical user interface display function; and using the selected particular active graphical user interface object to perform the active graphical user interface display operation.

A third embodiment of the present invention comprises a memory medium for storing a computer program component executable by a digital processor of a electronic device, where the computer component operates in combination with an operating system of the electronic device to confer modularity on active graphical user interface objects generated and controlled by the operating system of the electronic device, and where the computer program component performs the following operations when executed by the digital processor of the electronic device: receiving a command to initiate an active graphical user interface object selection process; for each graphical user interface function, displaying a selection of active graphical user interface objects available to perform that graphical user interface function; receiving a selection of an active graphical user interface object to be used to perform that graphical user interface function; and saving the selection of the active graphical user interface object to be used to perform that graphical user interface function; and displaying the graphical user interface using the active graphical user interface objects selections.

A fourth embodiment of the present invention comprises an electronic device comprising: at least one memory for storing a graphical user interface control program and an active graphical user interface object selection program, where the active graphical user interface object selection program operates to confer modularity on active graphical user interface objects generated by the graphical user interface control program; a display for displaying graphical user interfaces comprised, at least in part, of active graphical user interface objects, whereby the active graphical user interface objects perform active graphical user interface display functions; at least one input device for entering commands to control the electronic device; and a processing unit coupled to the at least one memory, display and the at least one input device for executing the graphical user interface control program and the active graphical user interface object selection program, whereby when the active graphical user interface object selection program is executed the following operations are performed: displaying a selection menu depicting a plurality of active graphical user interface objects available to perform an active graphical user interface display function; receiving a command selecting a particular active graphical user interface object to perform the active graphical user interface display function; and saving the selection of the active graphical user interface object selected to perform the active graphical user interface display function to the memory of the electronic device.

A fifth embodiment of the present invention comprises a processor-implemented method for use in an electronic device having a display for displaying a graphical user interface comprised of at least one active graphical user interface object, whereby the at least one active graphical user interface object performs an active graphical user interface display function, the method comprising: displaying a selection menu on the display of the electronic device, the selection menu showing a plurality of active graphical user interface objects available to perform the active graphical user interface display function; receiving a command selecting a particular active graphical user interface object to perform the active graphical user interface display function; and using the selected particular active graphical user interface object to perform the active graphical user interface display function.

A sixth embodiment of the present invention comprises an electronic device comprising: memory means for storing a graphical user interface control program and an active graphical user interface object selection program, where the active graphical user interface object selection program operates to confer modularity on active graphical user interface objects generated by the graphical user interface control program; display means for displaying graphical user interfaces comprised, at least in part, of active graphical user interface objects, whereby the active graphical user interface objects perform active graphical user interface display functions; input device means for entering commands to control the electronic device; and processor means coupled to the memory means, display means and the input device means, the processor means for executing the graphical user interface control program and the active graphical user interface object selection program, whereby when the active graphical user interface object selection program is executed the following operations are performed: displaying a selection menu depicting a plurality of active graphical user interface objects available to perform an active graphical user interface display function; receiving a command selecting a particular active graphical user interface object to perform the active graphical user interface display function; and saving the selection of the active graphical user interface object selected to perform the active graphical user interface display function to the memory of the electronic device.

Thus it is seen that embodiments of the present invention overcome the limitations of the prior art. In conventional portable communications devices and other electronic devices controlled by operating systems and interactive graphical user interfaces, users have had a relatively limited ability to customize functional features of these devices. For example, most customizability has concerned the “feel” of the device, and not the functionality of the device. In addition, the ability to change the “feel” of the device has been limited to relatively static features like background images and ringing tones. Heretofore there has been limited or no ability to customize active graphical user interface objects. Thus, although a user could select background images or distinctive ringing tones, functional aspects of user-controlled electronic devices are pre-determined and not subject to user selection and customization except for perhaps, the size of the display, font type, icons displayed, etc.

In contrast, the methods and apparatus of the present invention provide users with the ability to customize dynamic aspects of graphical user interfaces for use in portable communications devices. For example, in one embodiment, the methods and apparatus of the present invention provide an operating system with a modular active graphical user interface feature. This feature allows a user to customize the active elements of the graphical user interfaces that are used to control the electronic device. Instead of a prosaic table for displaying messaging history, a user can select active elements that metaphorically represent messaging history using more artistic active elements. In one embodiment of the present invention, this feature would be implemented through a user-accessible menu. The user-accessible menu would be presented to the user, for example, just after the user has purchased the device and has activated it for the first time. The user could simply elect to use conventional graphical user interface elements and presentation formats, or in accordance with the present invention, for each active graphical user interface function, select an active graphical user interface object to perform the function. After completing a selection process for each active graphical user interface function, the user would have a suite of graphical user interfaces comprised of customized active graphical user interface objects.

A particular advantage of the methods and apparatus of the present invention is that they implement active graphical user interface objects that are responsive to a broader range of contexts than conventional methods and apparatus. The modularity of operating systems programmed in accordance with the present invention allows users to add active graphical user interface objects that are sensitive to new categories of information. Such context-aware active graphical user interface objects serve to increase a user's overall awareness of events, and thus increase the utility of portable communications devices.

Other embodiments of the present invention operate for users who have already customized their graphical user interface suite by selecting active graphical user interface objects for various active graphical user interface functions, or for users who merely want to select one or two different active graphical user interface objects to be used in combination with a conventional graphical user interface. These embodiments would operate in a similar manner to the preceding embodiment but instead of selecting active graphical user interface objects for all of the graphical user interface functions, the user would select only the graphical user interface function that the user desired to change and then select a new active graphical user interface object to be used to perform the graphical user interface function.

Further embodiments of the present invention operate to provide third parties with the ability to add custom-made active graphical user interface objects to those already available in the operating system of the electronic device. In particular, the operating system of the present invention recognizes new active graphical user interface objects when the objects are, for example, downloaded to the electronic device. Then, when a user desires to change an active graphical user interface object used to perform a graphical user interface display function, the newly-downloaded active graphical user interface object would be presented as an available option to perform the graphical user interface display function. In addition, in instances where active graphical user interface objects integrated in an operating system function in accordance with the present invention have multiple features that are user-selectable, then the operating system of the present invention provides the user with the ability to select these features.

In conclusion, the foregoing summary of the embodiments of the present invention is exemplary and non-limiting. For example, one skilled in the art will understand that one or more aspects or steps from one embodiment can be combined with one or more aspects or steps from another embodiment of the present invention to create a new embodiment within the scope of the present invention.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 depicts a wireless communications system in which the methods of the present invention can be practiced;

FIG. 2 depicts a graphical user interface of a wireless communications device having conventional, pre-determined and non-user selectable active graphical user interface objects operating in accordance with the prior art;

FIG. 3 depicts a graphical user interface of a wireless communications device having novel, user-selected active graphical user interface objects operating in accordance with the present invention;

FIG. 4 depicts another graphical user interface of a user-controlled electronic device having communication functions, where the graphical user interface integrates novel, user-selected active graphical user interface objects operating in accordance with the present invention;

FIG. 5 depicts a further graphical user interface of a user-controlled electronic device having communications functions, where the graphical user interface integrates novel, user-selected active graphical user interface objects operating in accordance with the present invention;

FIG. 6 is a block diagram depicting software modules of an operating system conferring modularity on those aspects of the operating system controlling active graphical user interface objects, where the operating system functions in accordance with the present invention;

FIG. 7 is a flow chart depicting the steps of a method operating in accordance with the present invention;

FIG. 8 is a flow chart depicting the steps of a method operating in accordance with the present invention; and

FIG. 9 is a flow chart depicting the steps of a method operating in accordance with the present invention.

### DETAILED DESCRIPTION OF THE PREFERRED EMBODIMENTS

The methods and apparatus of the present invention can be practiced in any electronic device having an operating system which controls a graphical user interface that provides context-related and other categories of information to users through the graphical user interface. Electronic devices within the meaning of the present invention include, but are not limited to, portable communications devices (such as, for example, cellular telephones), personal digital assistants, computers, game controllers, etc.

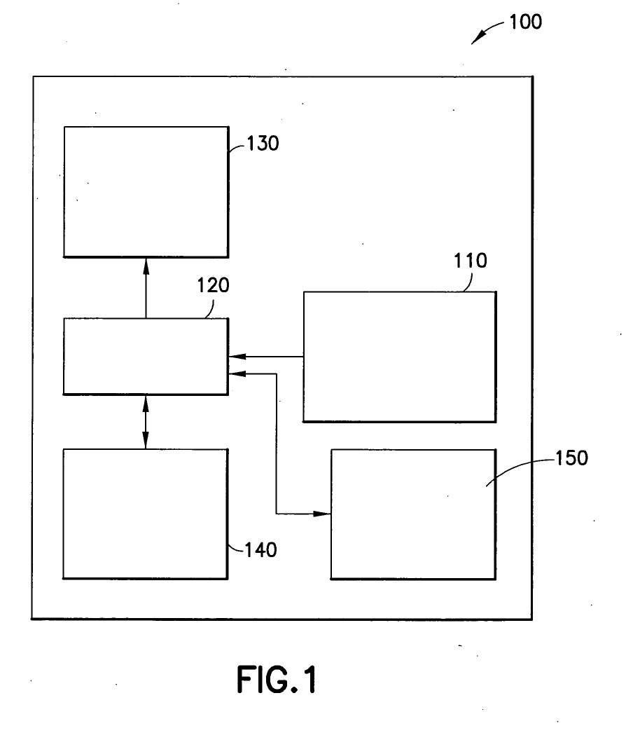

FIG. 1 depicts the common features of an electronic device 100 that is suitable for practicing the methods of the present invention. The electronic device comprises a user input device 110 for inputting commands to the electronic device 110. The user input device 110 can comprise touch-initiated information entry systems (such as, for example, buttons; multi-function controllers; keyboards; keypads; and touch screens); input elements contained in a graphical user interface depicted on a display 130; voice-activated information entry systems; and combinations thereof. The user input device is coupled to a processing unit 120. The processing unit 120 is operable to execute programs stored in memory 140; to act on data stored in memory 140; to respond to commands entered with user input device 110, and to control the display of graphical user interfaces on display unit 130. The electronic device 100 further comprises an interface 150 for connecting the electronic device to, for example, a network so that new program components or information can be downloaded to the device.

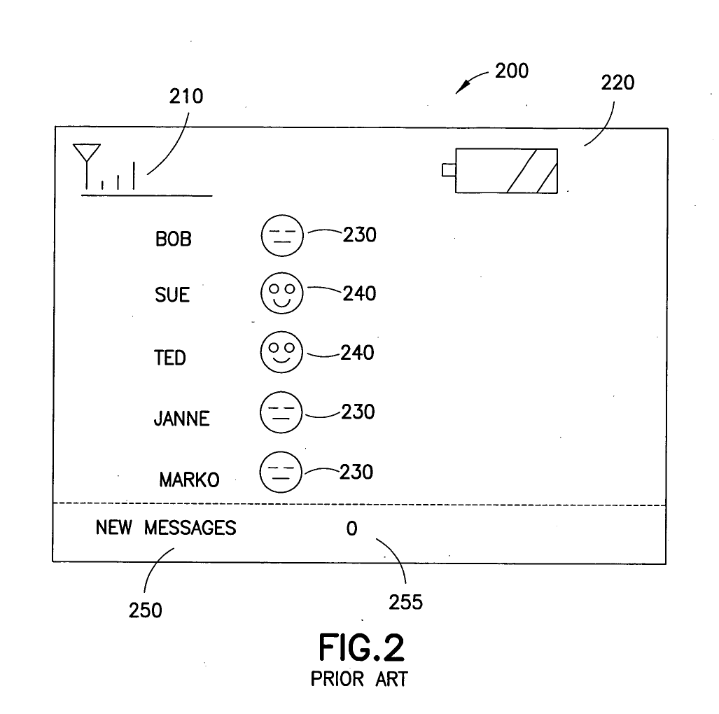

FIG. 2 depicts a conventional graphical user interface 200 that may be used in a user-controlled electronic device such as, for example, a wireless telephone. As is apparent, there are conventional active graphical user interface objects used to perform active graphical user interface functions. For example, there are active icons 210, 220 used to depict the signal and battery strengths, respectively. In addition, there is a table of instant messaging contacts which indicates whether the contacts are on line. The sleepy face icon state 230 indicates that the user is off-line, while the smiley face 240 indicates that the user is currently on-line. Further, there is a text line 250 and count indicator 255 for indicating whether the user of the cellular telephone has received any new messages. In conventional operating systems, active graphical user interface objects like battery and signal strength indicators 210, 220 are pre-determined and not user-selectable. Accordingly, in the prior art although a user may have the option to select a background image for use in combination with the graphical user interface of FIG. 2, the user has little or no control over other active graphical user interface objects which provide the true functionality of the graphical user interface.

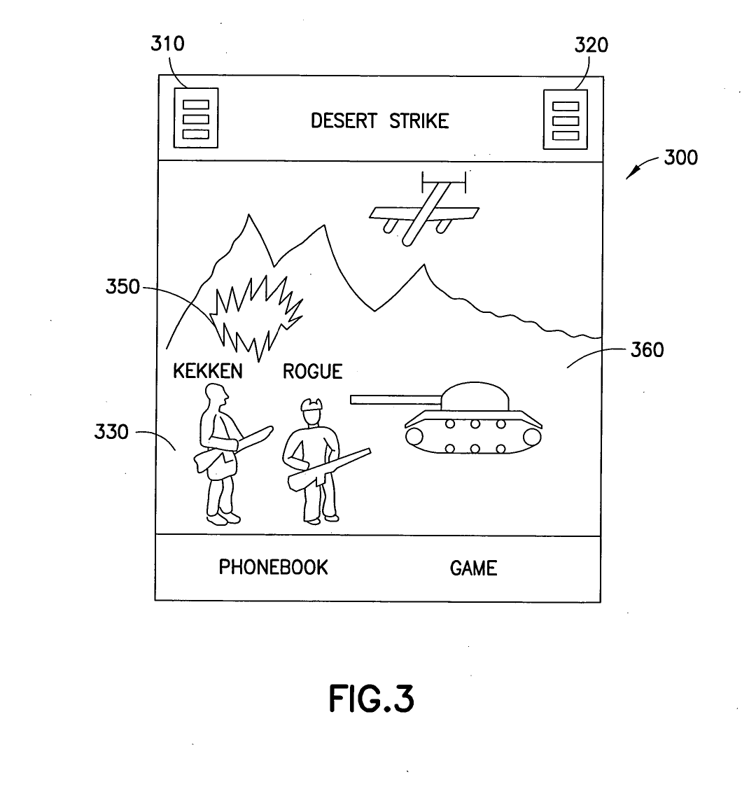

In contrast, methods and apparatus of the invention provide users with a modular operating system that allows users to select from among a plurality of active graphical user interface objects to perform various active graphical user interface functions. This provides users of electronic devices with a far greater ability to customize the operation, feel and appearance of graphical user interfaces used to interact with and control the electronic device. An example of a graphical user interface 300 that has been customized using the methods and apparatus of the invention is depicted in FIG. 3. The graphical user interface 300 depicted in FIG. 3 has been customized to mimic the overall appearance and feel of a game that is the favorite of a user. The signal and battery strength active graphical user interface objects 310, 320 are presented in a similar way to health statistics in the game. Active graphical user interface objects used to represent whether the users are on-line or not appear as soldiers 330, 340. An explosion 350 is used to indicate that a message has been received.

A particular advantage of the present invention is the ability to add new active graphical user interface display functions responsive to new categories of information, especially categories of information that increase the contextual awareness of a user. For example, if an on-line game is of particular interest to a user, the modularity of operating systems programmed in accordance with the present invention allows users to add new active graphical user interface display functions related to the game. One example is depicted in FIG. 3, where active graphical user interface objects 330, 340 indicate whether friends of the user are currently participating in an on-line game. For example, if the friends are not participating in the game, the objects 330, 340 would appear as grayscale images. Once the friends joined an on-line game the objects 330, 340 would appear in full color. Other game-related information could be relayed through active graphical user interface objects to provide or to increase the contextual awareness of a user. For example, the background image 360 can be synchronized to the background image of the game.

Context-related information often is dynamic in nature and changes with time. Accordingly, active graphical user interface objects operating in accordance with the present invention typically change appearance in dependence on the information to be displayed.

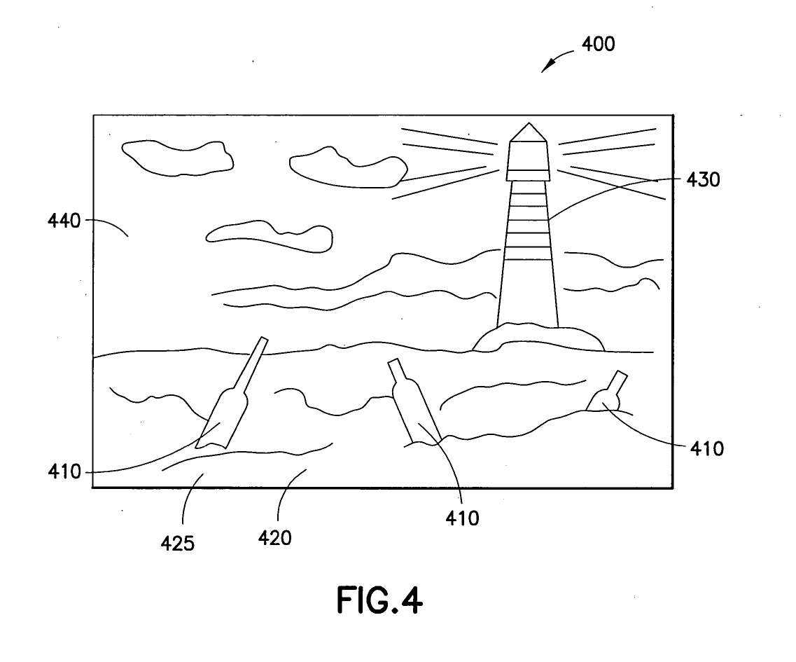

Methods and apparatus of the present invention find wide application. For example, the methods and apparatus of the present invention have been applied to a message in-box screen of a communications device in FIG. 4. In this embodiment, visual, context-aware metaphors implemented in active graphical user interface objects have replaced more prosaic and conventional interface objects. Instead of a message table, new messages are indicated by bottles 410 floating in a virtual sea 420. Each time the user receives a new message, a new bottle 410 is added to the collection floating on the virtual sea 420. The surface 425 of the virtual sea 420 itself has meaning in this embodiment, and is tied to some level of activity being monitored by the operating system of the electronic device. For example, if the surface 425 of the sea had been tied to a common document being worked on by multiple parties, the appearance of the surface would change depending upon the level of activity of the multiple parties. The more activity occurring, the more rough the sea would appear. This active graphical user interface object 425 thus provides contextual awareness to users. Further aspects of the user interface perform other context-aware notification functions. The virtual lighthouse 430 has been selected to indicate scheduling messages received by the user. In this example, the user has received a message from a co-worker that a meeting is to occur in fifteen minutes, so the virtual lighthouse 430 begins flashing. The sky 440 has been selected to indicate the expected weather state a pre-determined number of hours in the future, thus providing another category of context-aware information.

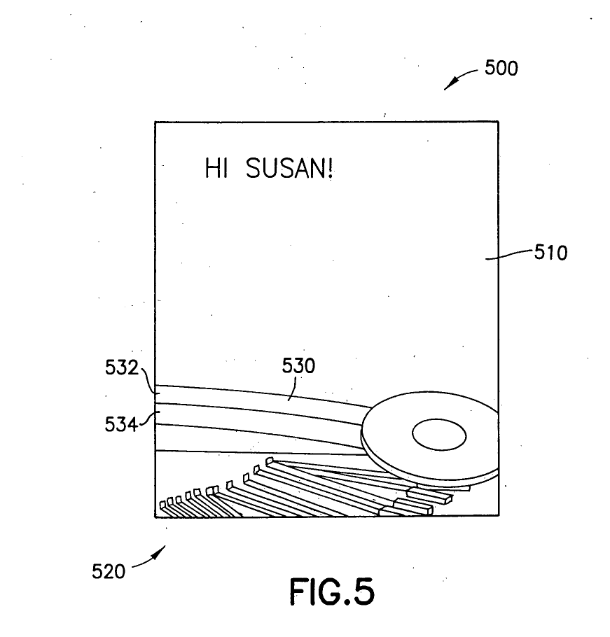

A further embodiment depicted in FIG. 5 depicts a graphical user interface 500 that has been selected for use with a messaging component of an operating system of an electronic device. Instead of letters and numbers merely appearing after a cursor as in the case of typical graphical user interfaces implementing text messaging functions, a dynamic active graphical user interface object 510 implementing a typewriter-like metaphor is depicted in the graphical user interface 500 of FIG. 5. Dynamic aspects of the active graphical user interface object are programmed to indicate various activities and/or states. For example, animated swinging of virtual typewriter keys 520 indicates the progress of drafting a message. The vibrancy of the red 532 and black 534 of the typewriter ribbon 530 indicates how much typing the user has done recently.

Now that aspects of graphical user interfaces operating in accordance with the present invention have been described, the methods and apparatus of the present invention that provide these aspects will be described. In particular, one aspect of the present invention comprises an operating system with modular active graphical user interface ability. In such an operating system, various active graphical user interface display functions are implemented. The active graphical user interface display functions have parameters that are used by active graphical user interface objects to perform the functions. The number and nature of these parameters are typically described in a software developer's kit (“SDK”) which provides guidelines and information for third parties seeking to develop “custom” active graphical user interface objects for the graphical user interfaces controlled by the operating system. In a typical commercial user-controllable electronic device operating in accordance with the present invention, multiple active graphical user interface objects would be available to perform various active graphical user interface display functions.

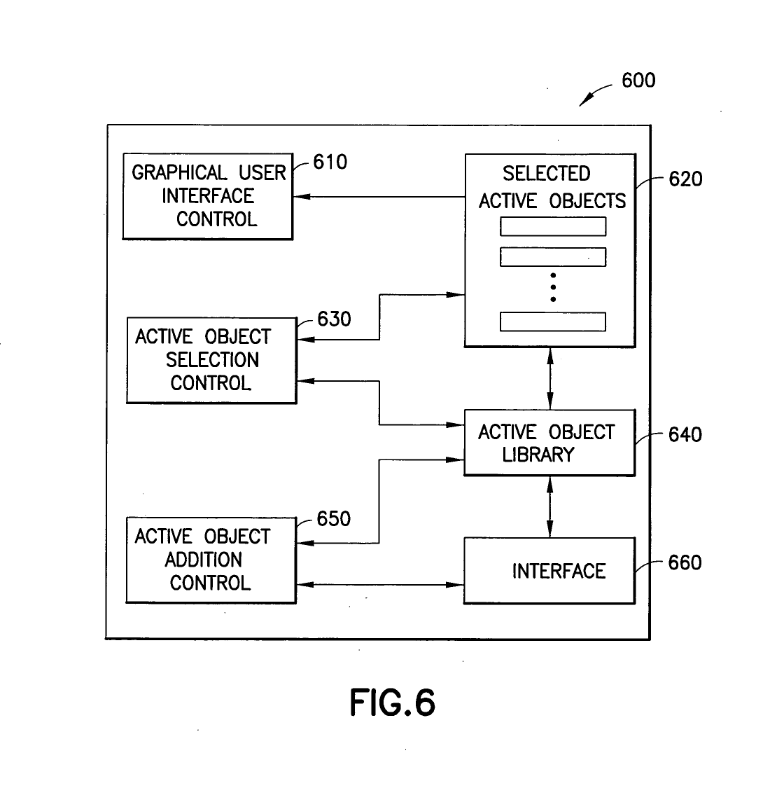

FIG. 6 depicts in conceptual form the software component elements that comprise an operating system capable of functioning in accordance with the present invention. Component 610 operates in combination with other aspects of the operating system (not shown) to determine what should be displayed. Component 620 comprises an index of selected active graphical user interface objects that are to be used when performing display operations. Since the active graphical user interface objects were created according to a template set forth, for example, in an SDK, they are designed to receive parameter values from the graphical user interface control 610 and to display them on a graphical user interface. An operating system functioning in accordance with the present invention further comprises an active graphical user interface object selection control component 630 that operates to permit users to select which active graphical user interface objects should be used to perform particular active graphical user interface functions. As is apparent in FIG. 6, the selection control component is coupled to the active object library 640, which is in turn coupled to the selected active graphical user interface object index component 620.

Another advantage of the present invention is that new active graphical user interface objects can be added (by, for example, downloading) to the active object library 640. The addition operations are controlled by active object addition control component 650 which analyzes new active graphical user interface objects that have been downloaded through interface 660 to determine which active graphical user interface functions the objects are designed to perform. The active object library 640 is updated by the active object addition control component 650 with information concerning the availability of a new active graphical user interface object, and with the functions that can be performed by the new active graphical user interface object.

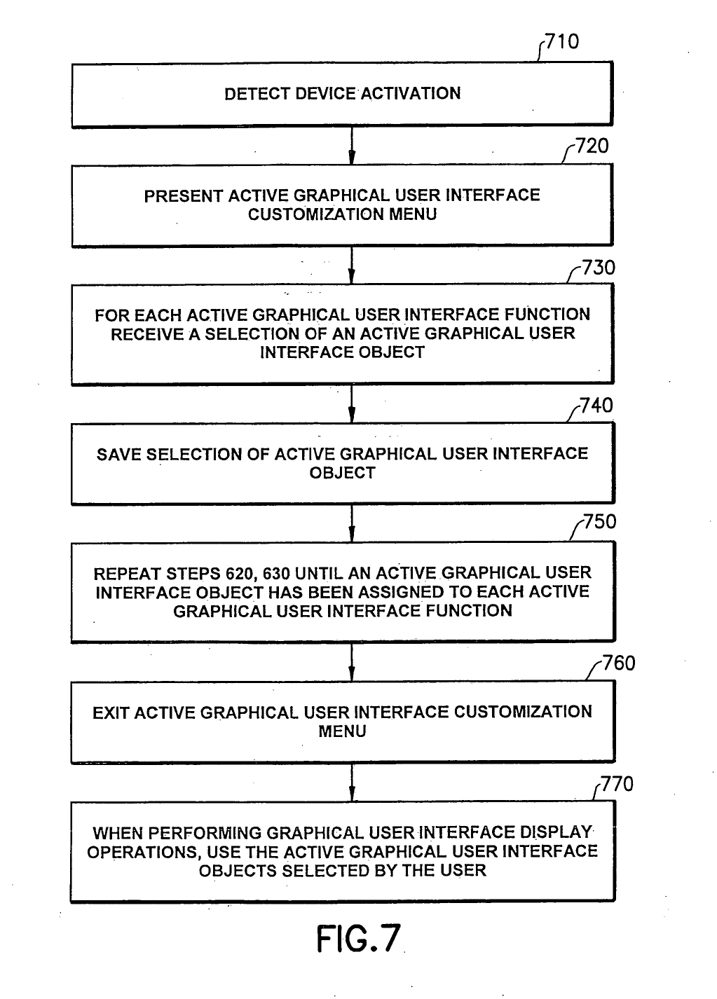

The methods and computer program products of the present invention will now be described. One method of the present invention operates whenever a user first activates a device operating in accordance with the present invention, or whenever a user desires to modify the operation of active graphical user interface objects of a graphical user interface. As depicted in FIG. 7, at step 710, an operating system detects that an electronic device programmed in accordance with the present invention has been activated for the first time by a user. Then, at step 720, the operating system presents an active graphical user interface object customization menu to the user. Next, at step 730 the user is presented with a group of available active graphical user interface objects that are designed to perform a particular active graphical user interface function. The operating system receives a selection of a particular active graphical user interface object to perform that active graphical user interface display function. Then, at step 740 the operating system saves the selection of the active graphical user interface object chosen to perform that active graphical user interface function to computer memory. Step 750 indicates that steps 730, 740 are repeated until all active graphical user interface functions have been assigned an active graphical user interface object or objects. Next, after the customization has been performed, the operating system exits the active graphical user interface customization menu. During operation, step 770 indicates that the operating system will use the active graphical user interface objects selected by the user with the customization menu to perform the active graphical user interface display functions.

In variants of the embodiment depicted in FIG. 7 additional steps can be performed. For example, during the selection process of active graphical user interface objects a preview step may be performed. In the preview step, the operating system would receive a tentative selection of an active graphical user interface object. For that tentative selection, the operating system would provide an animation simulating the behavior of the active graphical user interface object. This would assist the user in making selections that are agreeable to the user; the user would not have to wait until actual functioning of the operating system to see how the active graphical user interface objects appear. In another variant of the method depicted in FIG. 7, the user would be presented with the option to exit the selection menu after each assignment of an active graphical user interface object to an active graphical user interface function if the user decides she has customized enough of the features.

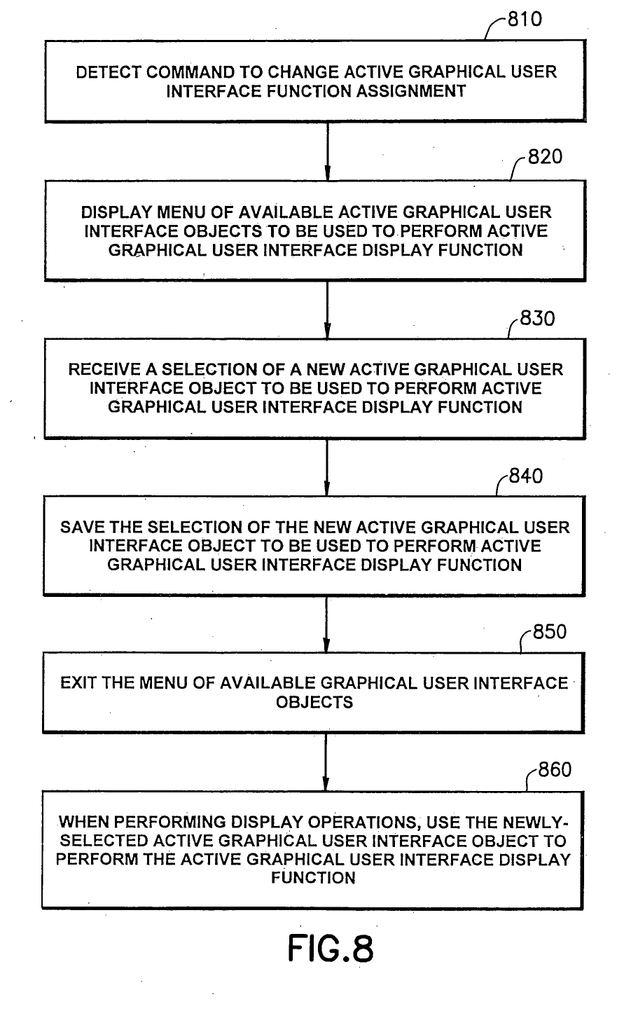

Another method of the present invention is depicted in FIG. 8 and operates when a user would like to change an assignment of an active graphical user interface object used to perform an active graphical user interface display function. At step 810, the operating system detects a command to change an active graphical user interface display function assignment. Next, at step 820 the operating system displays a menu of available active graphical user interface objects to be used to perform the active graphical user interface display function. Then at step 830 the operating system receives a selection of a new active graphical user interface object to be used to perform the active graphical user interface function. Next, step 840 the operating system saves the selection of the new active graphical user interface object to be used to perform the active graphical user interface function. At step 850, the operating system exits the menu of available graphical user interface objects. Finally, as indicated at step 860, when performing display operations the newly-selected active graphical user interface object is used to perform the active graphical user interface display function.

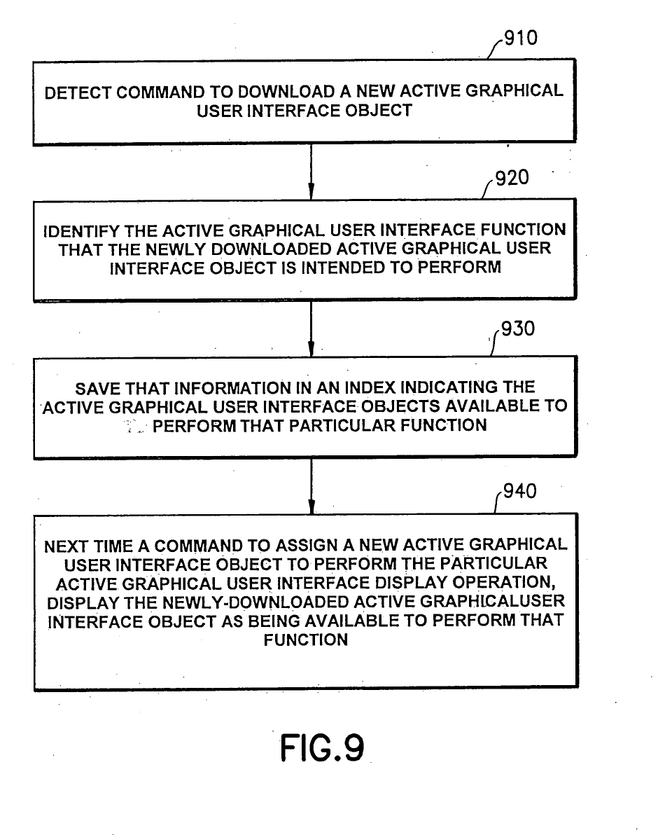

A further method of the present invention is depicted in FIG. 9 and operates to allow users to download new active graphical user interface objects for use in electronic devices. At step 910, the method detects a command to download a new active graphical user interface object. Then at step 920, the operating system identifies the active graphical user interface function that the newly downloaded active graphical user interface object is intended to perform. Next, at step 930, information identifying the particular active graphical user interface display function that the newly-downloaded active graphical user interface object is intended to perform is saved to an index in a memory of the electronic device. Finally, as indicated at step 940, the next time a command is detected to assign a new active graphical user interface object to the particular active graphical user interface display function, the newly-downloaded active graphical user interface object will be displayed in a menu of active graphical user interface objects available to perform that particular active graphical user interface display function.

One of ordinary skill in the art will understand that the methods depicted and described herein can be embodied in a tangible computer-readable memory medium. Instructions embodied in the tangible compute-readable memory medium perform the steps of the methods when executed. Tangible computer-readable memory media include, but are not limited to, hard drives, CD- or DVD-ROM, flash memory storage devices or in a RAM memory of a computer system.

Thus it is seen that the foregoing description has provided by way of exemplary and non-limiting examples a full and informative description of the best methods and apparatus presently contemplated by the inventors for implementing modular active graphical user interface object capability. One skilled in the art will appreciate that the various embodiments described herein can be practiced individually; in combination with one or more other embodiments described herein; or in combination with interactive graphical user interfaces differing from those described herein. Further, one skilled in the art will appreciate that the present invention can be practiced by other than the described embodiments; that these described embodiments are presented for the purposes of illustration and not of limitation; and that the present invention is therefore limited only by the claims which follow.

We claim:

1. A computer program for use in an electronic device having a display for displaying at least one graphical user interface comprised of active graphical user interface objects, the active graphical user interface objects performing active graphical user interface display functions for depicting dynamic information, the computer program fixed in a tangible memory medium and executable by a digital processor of the electronic device, the computer program comprised of the following components:
a library of active graphical user interface objects to perform a plurality of active graphical user interface display functions, where a plurality of active graphical user interface objects exist in the library to perform at least one of the plurality of active graphical user interface display functions;
an active graphical user interface object selection component for displaying active graphical user interface objects available to perform particular active graphical user interface display functions; for receiving selections of active graphical user interface objects to perform particular active graphical user interface display functions; and for saving the selections; and
an active graphical user interface object selection index for recording active graphical user interface objects selected to perform particular active graphical user interface display functions.

2. The computer program of claim 1 further comprising:
a graphical user interface display control component, the graphical user interface display control component operable to control active graphical user interface display functions to depict dynamic information, the active graphical user interface display control component retrieving selections of active graphical user interface objects selected to perform particular active graphical user interface display functions, and using the selected active graphical user interface objects to perform the particular active graphical user interface display functions.

3. The computer program of claim 1 where the active graphical user interface objects are context-aware, whereby the active graphical user interface objects are responsive to at least one predetermined category of context-related, dynamic information.

4. The computer program of claim 2 where at least one of the active graphical user interface display functions operates according to a template, where the template identifies at least one input parameter corresponding to data provided to the active graphical user interface object performing the active graphical user interface display function during display operations by the graphical user interface display control component.

5. The computer program of claim 4 where the active graphical user interface object receiving data provided by the graphical user interface display control component changes in appearance in dependence on the data.

6. The computer program of claim 1 where at least one of the active graphical user interface display functions comprise a battery charge indicator, and whereby multiple active graphical user interface objects are present in the library of active graphical user interface objects to perform the battery charge indicator function.

7. The computer program of claim 1 where the electronic device comprises a wireless communications device and at least one of the active graphical user interface display functions comprises a signal strength indicator, whereby multiple active graphical user interface objects exist in the library of active graphical user interface objects to perform the signal strength indicator function.

8. The computer program of claim 1 where the electronic device is operative to perform a communications function and at least one of the active graphical user interface display functions comprises a message in-box, whereby multiple active graphical user interface objects exist in the library of active graphical user interface objects to perform the message in-box function.

9. The computer program of claim 1 where the electronic device is operative to perform a communications function and at least one of the active graphical user interface display functions comprises an on-line status indicator, whereby multiple active graphical user interface objects exist in the library of active graphical user interface objects to perform the on-line status indicator function.

10. The computer program of claim 1 where the electronic device is operative to perform a communications function and at least one of the active graphical user interface display functions comprises a message receipt indicator, whereby multiple active graphical user interface objects exist in the library of active graphical user interface objects to perform the message receipt indicator function.

11. The computer program of claim 1 where at least one of the active graphical user interface display functions comprises a weather report feature, whereby multiple graphical user interface objects exist in the library of active graphical user interface objects to perform the weather report feature.

12. The computer program of claim 1 where the electronic device comprises a portable communications device and where at least one of the active graphical user interface display functions comprises an on-line computer game monitor.

13. The computer program of claim 1 where the electronic device comprises a portable communications device and where at least one of the active graphical user interface objects adopts the appearance of graphical elements of a computer game.

14. The computer program of claim 13 where a plurality of active graphical user interface objects adopt the appearance of graphical elements of a particular computer game, thereby allowing a user to impart a computer-game-like feel to graphical user interfaces of the portable communications device.

15. The computer program of claim 1 further comprising:
an active graphical user interface object addition control component for updating the library of active graphical user interface objects when new active graphical user interface objects are added to the library.

16. The computer program of claim 1 further comprising:
a new context-aware category addition-control component for adding a new active graphical user interface display function responsive to a new category of context-related information.

17. The computer program of claim 16 further comprising:
an active graphical user interface object addition-control component for adding new active graphical user interface objects operative to perform the new active graphical user interface display function added with the new context-aware category addition control component, whereby the new active graphical user interface objects are responsive to the new category of context-related information.

18. A memory medium for storing a computer program component executable by a digital processor of an electronic device, where the computer program component operates in combination with an operating system of the electronic device to confer modularity on active graphical user interface objects used by the operating system of the electronic device to perform active graphical user interface display functions, and where the computer program component performs the following operations when executed by the digital processor of the electronic device:
displaying a selection menu depicting a plurality of active graphical user interface objects available to perform an active graphical user interface display function;
receiving a command selecting a particular active graphical user interface object to perform the active graphical user interface display function; and
using the selected particular active graphical user interface object to perform the active graphical user interface display operation.

19. The memory medium of claim 18 where the active graphical user interface objects are context-aware, whereby the active graphical user interface objects are responsive to at least one predetermined category of context-related, dynamic information.

20. A memory medium for storing a computer program component executable by a digital processor of a electronic device, where the computer component operates in combination with an operating system of the electronic device to confer modularity on active graphical user interface objects generated and controlled by the operating system of the electronic device, and where the computer program component performs the following operations when executed by the digital processor of the electronic device:
receiving a command to initiate an active graphical user interface object selection process;
for each graphical user interface function, displaying a selection of active graphical user interface objects available to perform that graphical user interface function; receiving a selection of an active graphical user interface object to be used to perform that graphical user interface function; and saving the selection of the active graphical user interface object to be used to perform that graphical user interface function; and
displaying the graphical user interface using the active graphical user interface objects selections.

21. The memory medium of claim 20 whereby at least one of the active graphical user interface objects is context-aware, whereby the context-aware active graphical user interface object is responsive to at least one predetermined category of context-related, dynamic information.

22. An electronic device comprising:
at least one memory for storing a graphical user interface control program and an active graphical user interface object selection program, where the active graphical user interface object selection program operates to confer modularity on active graphical user interface objects generated by the graphical user interface control program;
a display for displaying graphical user interfaces comprised, at least in part, of active graphical user interface objects, whereby the active graphical user interface objects perform active graphical user interface display functions;
at least one input device for entering commands to control the electronic device; and
a processing unit coupled to the at least one memory, display and the at least one input device for executing the graphical user interface control program and the active graphical user interface object selection program, whereby when the active graphical user interface object selection program is executed the following operations are performed:
displaying a selection menu depicting a plurality of active graphical user interface objects available to perform an active graphical user interface display function;
receiving a command selecting a particular active graphical user interface object to perform the active graphical user interface display function; and
saving the selection of the active graphical user interface object selected to perform the active graphical user interface display function to the memory of the electronic device.

23. The electronic device of claim 22 whereby at least one of the active graphical user interface objects is context-aware, whereby the context-aware active graphical user interface object is responsive to at least one predetermined category of context-related information.

24. The electronic device of claim 22, where at least one of the active graphical user interface objects adopts the appearance of at least one graphical element of a computer game.

25. The electronic device of claim 24 where a plurality of active graphical user interface objects adopt the appearance of graphical elements of a particular computer game, thereby allowing a user to impart a computer-game-like feel to graphical user interfaces of the mobile station.

26. The electronic device of claim 22 whereby when the processing unit executes the graphical user interface control program, the following operation is performed:
using the selected active graphical user interface object to perform the active graphical user interface display function.

27. A processor-implemented method for use in an electronic device having a display for displaying a graphical user interface comprised of at least one active graphical user interface object, whereby the at least one active graphical user interface object performs an active graphical user interface display function, the method comprising:
displaying a selection menu on the display of the electronic device, the selection menu showing a plurality of active graphical user interface objects available to perform the active graphical user interface display function;
receiving a command selecting a particular active graphical user interface object to perform the active graphical user interface display function; and
using the selected particular active graphical user interface object to perform the active graphical user interface display function.

28. An electronic device comprising:
memory means for storing a graphical user interface control program and an active graphical user interface object selection program, where the active graphical user interface object selection program operates to confer modularity on active graphical user interface objects generated by the graphical user interface control program;
display means for displaying graphical user interfaces comprised, at least in part, of active graphical user interface objects, whereby the active graphical user interface objects perform active graphical user interface display functions;
input device means for entering commands to control the electronic device; and
processor means coupled to the memory means, display means and the input device means, the processor means for executing the graphical user interface control program and the active graphical user interface object selection program, whereby when the active graphical user interface object selection program is executed the following operations are performed:
displaying a selection menu depicting a plurality of active graphical user interface objects available to perform an active graphical user interface display function;
receiving a command selecting a particular active graphical user interface object to perform the active graphical user interface display function; and
saving the selection of the active graphical user interface object selected to perform the active graphical user interface display function to the memory of the electronic device.
